(19) United States
(12) Patent Application Publication
(10) Pub. No.: US 2026/0219918 A1
(43) Pub. Date: Jul. 30, 2026

(54) DISTRIBUTED INTELLIGENCE DELIVERY SYSTEM

(71) Applicant: Dell Products L.P., Round Rock, TX (US)

(72) Inventors: Ryan N. COMER, Round Rock, TX (US); Anantha K. BOYAPALLE, Cedar Park, TX (US); Tyler R. COX, Austin, TX (US); Marc R. HAMMONS, Round Rock, TX (US); Jarrett SIMERSON, Northbrook, IL (US)

(73) Assignee: Dell Products L.P., Round Rock, TX (US)

(21) Appl. No.: 19/037,553

(22) Filed: Jan. 27, 2025

(51) Int. Cl. G06F 9/48

(52) U.S. Cl. CPC G06F 9/48

(57) ABSTRACT

An information handling system may include a memory and a processor communicatively coupled to the memory, and configured to: store information regarding a plurality of compute nodes, including artificial intelligence capabilities and artificial intelligence workload telemetry for each of the plurality of compute nodes, in an enterprise tenant registry; receive an artificial intelligence model session request from an application executing on a client; based on the information regarding the plurality of compute nodes, select one or more compute nodes of the plurality of compute nodes for execution of the artificial intelligence model session; and load a model for the artificial intelligence model session to the one or more compute nodes selected to establish a model session, wherein the model session receives streamed input from the application and returns streamed output to the application.

### TECHNICAL FIELD

The present disclosure relates in general to information handling systems, and more particularly to methods and systems to enable independent software vendor applications to leverage local compute nodes or distributed compute ecosystems for execution of artificial intelligence workloads.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems are increasingly used for artificial intelligence. Artificial intelligence, in its broadest sense, is intelligence exhibited by machines, particularly information handling systems. Artificial intelligence is a field of research in computer science that develops and studies methods and software that enable machines to perceive their environment and use learning and intelligence to take actions that maximize their chances of achieving defined goals. Artificial intelligence models are executable programs that detect specific patterns using a collection of data sets. A model may be thought of as an illustration of a system that can receive data inputs and draw conclusions or conduct actions depending on those conclusions. An example of an artificial model is a neural network, which may be a model that makes decisions in a manner similar to the human brain, by using processes that mimic the way biological neurons work together to identify phenomena, weigh options and arrive at conclusions.

Traditionally, most of the artificial intelligence workloads that exist for independent software vendor (ISV) applications are executed in the cloud. This is primarily due to limited compute capacity that traditionally exists on local clients. Artificial intelligence workloads that execute in the cloud benefit from high performance compute platforms but suffer from rising cloud costs. This is beginning to change with the advent of new local compute platforms (e.g., neural processing units) which can run these artificial intelligence workloads locally. However, the software for these new compute platforms is in its infancy. ISVs are hesitant to integrate with local compute platforms until the software stack has become standardized. Sometimes, ISVs create their own vertical solutions that take advantage of neural processing units to execute their workloads locally. However, doing so may render the neural processing unit less available for other software that could also benefit by running its workload on the neural processing unit.

### SUMMARY

In accordance with the teachings of the present disclosure, the disadvantages and problems associated with existing approaches to execution of artificial intelligence workloads may be reduced or eliminated.

In accordance with embodiments of the present disclosure, an information handling system may include a memory and a processor communicatively coupled to the memory, and configured to: store information regarding a plurality of compute nodes, including artificial intelligence capabilities and artificial intelligence workload telemetry for each of the plurality of compute nodes, in an enterprise tenant registry; receive an artificial intelligence model session request from an application executing on a client; based on the information regarding the plurality of compute nodes, select one or more compute nodes of the plurality of compute nodes for execution of the artificial intelligence model session; and load a model for the artificial intelligence model session to the one or more compute nodes selected to establish a model session, wherein the model session receives streamed input from the application and returns streamed output to the application.

In accordance with these and other embodiments of the present disclosure, a method may include storing information regarding a plurality of compute nodes, including artificial intelligence capabilities and artificial intelligence workload telemetry for each of the plurality of compute nodes, in an enterprise tenant registry. The method may also include receiving an artificial intelligence model session request from an application executing on a client and based on the information regarding the plurality of compute nodes, selecting one or more compute nodes of the plurality of compute nodes for execution of the artificial intelligence model session. The method may further include loading a model for the artificial intelligence model session to the one or more compute nodes selected to establish a model session, wherein the model session receives streamed input from the application and returns streamed output to the application.

In accordance with these and embodiments of the present disclosure, an article of manufacture may include a non-transitory computer-readable medium and computer-executable instructions carried on the computer-readable medium, the instructions readable by a processor, the instructions, when read and executed, for causing the processor to: store information regarding a plurality of compute nodes, including artificial intelligence capabilities and artificial intelligence workload telemetry for each of the plurality of compute nodes, in an enterprise tenant registry; receive an artificial intelligence model session request from an application executing on a client; based on the information regarding the plurality of compute nodes, select one or more compute nodes of the plurality of compute nodes for execution of the artificial intelligence model session; and load a model for the artificial intelligence model session to the one or more compute nodes selected to establish a model session, wherein the model session receives streamed input from the application and returns streamed output to the application.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example system for executing artificial intelligence workloads, in accordance with embodiments of the present disclosure; and

FIGS. 2A and 2B (which may be collectively referred to herein as FIG. 2), illustrate a flow chart of an example method for distributed intelligence delivery, in accordance with embodiments of the present disclosure.

### DETAILED DESCRIPTION

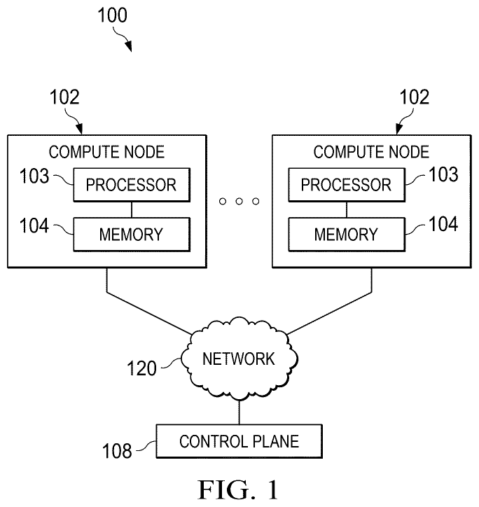

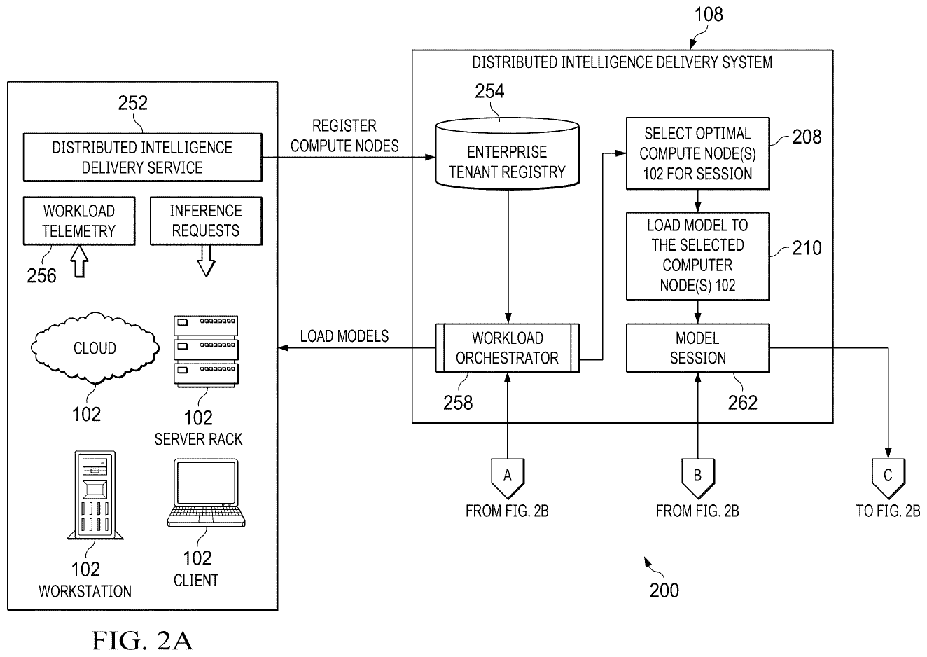

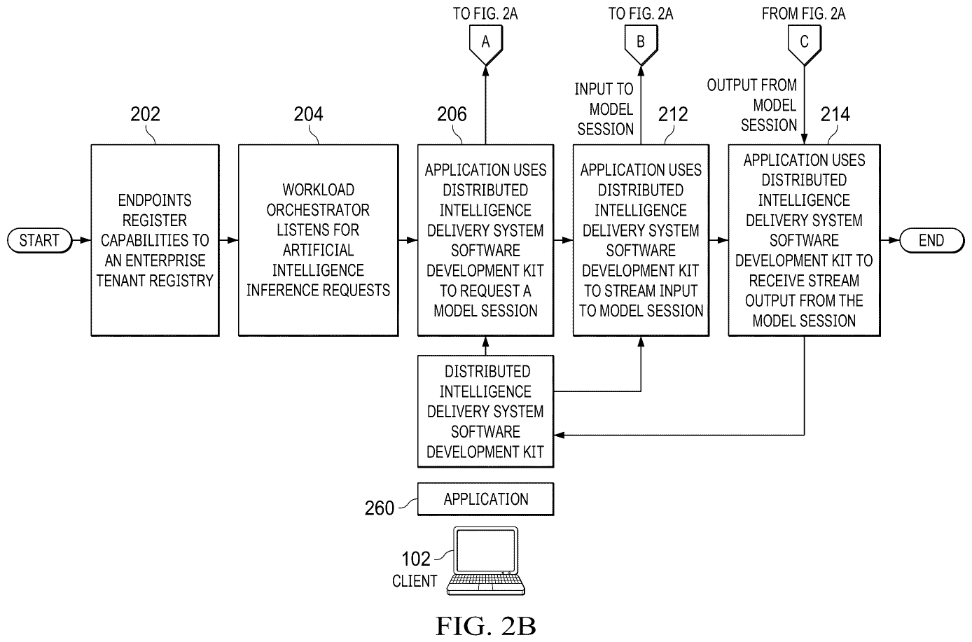

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example system 100 for executing artificial intelligence workloads, in accordance with embodiments of the present disclosure. As shown in FIG. 1, system 100 may include a plurality of compute nodes 102, a control plane 108, and a network 120.

Each compute node 102 may comprise an information handling system, as defined above. In operation, each compute node 102 may be configured to execute an artificial intelligence workload using the processing and memory resources thereof. The various compute nodes 102 in system 100 may represent different types of information handling systems within an enterprise. For example, one or more of compute nodes 102 may comprise servers, one or more of compute nodes 102 may comprise client information handling systems (e.g., a laptop, notebook, tablet, handheld, smart phone, personal digital assistant, etc.), one or more of compute nodes 102 may comprise edge devices, and one or more of compute nodes 102 may comprise cloud computing resources.

As depicted in FIG. 1, each compute node may include a processor 103, and a memory 104 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), graphics processing unit (GPU), neural processing unit (NPU), or any other digital or analog circuitry configured to interpret and/or execute program instructions and/or process data. In some embodiments, processor 103 may interpret and/or execute program instructions and/or process data stored in memory 104 and/or another component of a compute node 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to compute node 102 is turned off.

In operation, memory 104 may store all or a portion of an artificial intelligence model, data associated with the model, and executable instructions which may be read and executed by processor 103 to process the data in accordance with the model.

For purposes of clarity and exposition, each compute node 102 is depicted as only including a processor 103 and a memory 104. However, each compute node 102 may comprise other information handling resources not explicitly depicted in FIG. 1.

Control plane 108 may comprise any system, device, or apparatus configured to manage and control execution of artificial intelligence models on the various compute nodes 102. Accordingly, control plane 108 may execute one or more services, including an orchestrator service, for assisting the placement of artificial intelligence workloads for execution among the various compute nodes 102, as described in greater detail below. In some embodiments, control plane 108 may comprise an information handling system distinct from compute nodes 102. In other embodiments, control plane 108 may be a part of and/or executed by one of compute nodes 102. Although not shown in FIG. 1, control plane 108 may also include a processor (e.g., similar to processor 103), memory (e.g., similar to memory 104) and other information handling resources.

Network 120 may comprise a network and/or fabric configured to communicatively couple compute nodes 102 and control plane 108 to each other and/or one or more other information handling systems. In these and other embodiments, network 120 may include a communication infrastructure, which provides physical connections, and a management layer, which organizes the physical connections and information handling systems communicatively coupled to network 120. Network 120 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or any other appropriate architecture or system that facilitates the communication of signals, data and/or messages (generally referred to as data). Network 120 may transmit data via wireless transmissions and/or wire-line transmissions using any storage and/or communication protocol, including without limitation, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or any other transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. Network 120 and its various components may be implemented using hardware, software, or any combination thereof.

In operation, control plane 108 may execute a distributed intelligence delivery system in order to enable ISV applications to leverage local compute platforms or distributed compute ecosystems. Such distributed intelligence delivery system may enable deployment of models on a client making an inference request, cloud, or near edge that could perform inference and return the result to the client with as little latency as possible.

FIG. 2 illustrates a flow chart of an example method 200 for distributed intelligence delivery, in accordance with embodiments of the present disclosure. According to some embodiments, method 200 may begin at step 202. As noted above, teachings of the present disclosure may be implemented in a variety of configurations of system 100. As such, the preferred initialization point for method 200 and the order of the steps comprising method 200 may depend on the implementation chosen.

At step 202, all artificial intelligence capable compute nodes 102 in system 100 may execute a distributed intelligence delivery service 252 to register their capabilities with an enterprise tenant registry 254 of a distributed intelligence delivery system of control plane 108. As part of such registration, compute nodes 102 may also communicate their workload telemetry 256 to enterprise tenant registry 254. Communication of such workload telemetry 256 to enterprise tenant registry 254 may also be performed continuously, and may include the performance of artificial intelligence workloads that are placed on endpoint compute nodes 102.

At step 204, a workload orchestrator 258 of a distributed intelligence delivery service executed by control plane 108 may listen for artificial intelligence inference requests communicated from one or more clients of system 100, wherein each of the one or more clients may comprise compute nodes 102 of system 100.

At step 206, to make an artificial intelligence inference request, an application 260 (e.g., an ISV application) executing on a client compute node 102 may use a distributed intelligence delivery service software development kit to request a model session.

At step 208, workload orchestrator 258 may, based on capabilities of compute nodes 102, workload telemetry for compute nodes 102, and current loads upon compute nodes 102, select one or more optimal compute nodes 102 for execution of the requested model session. Selection of optimal compute node(s) 102 for execution of the requested model session may be performed in any suitable manner, including without limitation as described in U.S. application Ser. No. 18/991,853 filed Dec. 23, 2024; U.S. application Ser. No. 19/020,069 filed Jan. 14, 2025; U.S. application Ser. No. 19/020,328 filed Jan. 14, 2025; U.S. application Ser. No. 19/012,379 filed Jan. 7, 2025; and/or U.S. application Ser. No. 19/037,505 filed Jan. 27, 2025, all of which are incorporated by reference herein in their entireties.

During execution of step 208, workload orchestrator 258 may implement a voting/scoring system to reconcile competing priorities for model sessions among available optimal compute nodes 102 (including factors such as request priority, volume, complexity, schedule) with an objective of sustained system efficiency and performance (e.g., model thrashing may degrade to improve shorter-term request performance). This may impact selection, particularly in influencing the distributed intelligence delivery system to use compute nodes 102 where models are already loaded/resident for the given model session, and to not select/modify nodes that are likely to be reused for other workloads in the near future and/or with high priority.

At step 210, workload orchestrator 258 may load a model for the inference request to the selected compute node(s) 102 to establish a model session 262.

At step 212, application 260 may use the distributed intelligence delivery system software development kit to stream input to model session 262. At step 214, in response, application 260 may use the distributed intelligence delivery system software development kit to receive output from model session 262. After completion of step 212, method 200 may end.

Notably, a single model session may be active for multiple inference requests. Once a client establishes a model session, the client may send multiple inference requests. Once the client ends the session, the orchestrator may then decide to unload the model if it needs the space. Further, multiple sessions might use the same model, so the model may only be unloaded if it is unused.

Although FIG. 2 discloses a particular number of steps to be taken with respect to method 200, method 200 may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented in whole or part using a variety of configurations of system 100 and/or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described above, the principles of the present disclosure may be implemented using any number of techniques, whether currently known or not. The present disclosure should in no way be limited to the exemplary implementations and techniques illustrated in the figures and described above.

Unless otherwise specifically noted, articles depicted in the figures are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system comprising:
a memory; and
a processor communicatively coupled to the memory, and configured to:
store information regarding a plurality of compute nodes, including artificial intelligence capabilities and artificial intelligence workload telemetry for each of the plurality of compute nodes, in an enterprise tenant registry;
receive an artificial intelligence model session request from an application executing on a client;
based on the information regarding the plurality of compute nodes, select one or more compute nodes of the plurality of compute nodes for execution of the artificial intelligence model session; and
load a model for the artificial intelligence model session to the one or more compute nodes selected to establish a model session, wherein the model session receives streamed input from the application and returns streamed output to the application.

2. The information handling system of claim 1, wherein the artificial intelligence model session request is received via a distributed intelligence delivery system software development kit interfacing with the application.

3. The information handling system of claim 2, wherein the streamed input and the streamed output is communicated through the distributed intelligence delivery system software development kit.

4. A method comprising:
storing information regarding a plurality of compute nodes, including artificial intelligence capabilities and artificial intelligence workload telemetry for each of the plurality of compute nodes, in an enterprise tenant registry;
receiving an artificial intelligence model session request from an application executing on a client;
based on the information regarding the plurality of compute nodes, selecting one or more compute nodes of the plurality of compute nodes for execution of the artificial intelligence model session; and
loading a model for the artificial intelligence model session to the one or more compute nodes selected to establish a model session, wherein the model session receives streamed input from the application and returns streamed output to the application.

5. The method of claim 4, wherein the artificial intelligence model session request is received via a distributed intelligence delivery system software development kit interfacing with the application.

6. The method of claim 5, wherein the streamed input and the streamed output is communicated through the distributed intelligence delivery system software development kit.

7. An article of manufacture comprising:
a non-transitory computer-readable medium; and
computer-executable instructions carried on the computer-readable medium, the instructions readable by a processor, the instructions, when read and executed, for causing the processor to:
store information regarding a plurality of compute nodes, including artificial intelligence capabilities and artificial intelligence workload telemetry for each of the plurality of compute nodes, in an enterprise tenant registry;
receive an artificial intelligence model session request from an application executing on a client;
based on the information regarding the plurality of compute nodes, select one or more compute nodes of the plurality of compute nodes for execution of the artificial intelligence model session; and
load a model for the artificial intelligence model session to the one or more compute nodes selected to establish a model session, wherein the model session receives streamed input from the application and returns streamed output to the application.

8. The article of claim 7, wherein the artificial intelligence model session request is received via a distributed intelligence delivery system software development kit interfacing with the application.

9. The article of claim 8, wherein the streamed input and the streamed output is communicated through the distributed intelligence delivery system software development kit.
